(19) United States
(12) Patent Application Publication
(10) Pub. No.: US 2016/0318280 A1
(43) Pub. Date: Nov. 3, 2016

(54) TEXTILE PRODUCT AND USES THEREOF, METHOD TO PRODUCE SUCH A PRODUCT AND METHOD FOR RECYCLING THE PRODUCT

(71) Applicant: DSM IP ASSETS B.V., Heerlen (NL)

(72) Inventors: Chris REUTELINGSPERGER, Echt (NL); Martin Bruno WENNING, Emsdetten (DE)

(21) Appl. No.: 15/109,251

(22) PCT Filed: Jan. 9, 2015
(86) PCT No.: PCT/EP2015/050364

§ 371 Date: Jun. 30, 2016

(30) Foreign Application Priority Data
Jan. 10, 2014 (EP) 14150730.1

(51) Int. Cl. B32B 5/02; B32B 43/00; A47G 27/00; D06N 7/00

(52) U.S. Cl. CPC B32B 5/026; B32B 5/022; D06N 7/0065; D06N 7/0076; D06N 7/0081; D06N 7/0086; B32B 43/006; A47G 27/00; D06N 2213/02

(57) ABSTRACT

The invention pertains to a textile product which is a laminate of a first sheet having yarns fastened thereto, the first sheet having a first surface and a second surface, the yarns extending from the first surface, a second sheet and an intermediate layer between the second surface of the first sheet and the second sheet, wherein the second surface of the first sheet is calendered and the intermediate layer is resilient to allow local deformation of this layer along the second surface of the first sheet or along the surface of the second sheet adjacent to the intermediate layer. The invention also pertains to a method to produce such a textile product and to a method to recycle such a textile product.

### GENERAL FIELD OF THE INVENTION

The present invention pertains to a textile product and uses thereof, which textile product is a laminate of a first sheet having yarns fastened thereto, the first sheet having a first surface and a second surface, the yarns extending from the first surface, a second sheet and an intermediate layer between the second surface of the first sheet and the second sheet. The invention also pertains to a method to produce such a textile product and to a method to recycle such a textile product.

### BACKGROUND ART

With laminated textile products, for example broad loom carpet, carpet tiles, entrance mats, car mats, airplane and boat mats, runners etc. a particular problem to be addressed is internal strain in the laminate, in particular due to the influence of moist, temperature or other environmental variables. Internal strain on its turn may lead to various problems. With carpet tiles for example, internal strain may lead to the problem of curl: the edges or corners of the tiles tend to curl up. Curling of edges or corners is a problem since the edges in general to not coincide with an edge of the surface to be covered, and thus, the curled up edges or corners may lead to irregularities in center areas of the covered surface. With broadloom carpet, internal strain may lead to deformation such that interstices are formed at the joint of two sections of carpet. Also, for any laminated textile product, internal strain may lead to bulges and local excessive wear.

An important reason for the occurrence of internal strain is that the laminate inherently comprises different layers (note: the term “layer” or “sheet” does not exclude that the layer or sheet is actually constituted out different sub-layers) that need to provide very different properties to the textile product (from now on also called “carpet”, not excluding other types of textile products such as upholstery, clothing and wall coverings): the first sheet, also called primary backing, needs to stably bear the pile yarns. The second sheet, also called secondary backing, in general provides dimensional stability to the textile product. An intermediate layer may be provided to improve the (walking) comfort of the textile product or the wear resistance. For this reason, the structure of the different layers is inherently different. And thus, even when for example the first and second sheet are made of the same material, the occurrence of internal strain due to different deformations by the action of moist and temperature, is inherently present. The problem is even increased when different materials are being used for constituting the sheets, in particular when these materials per se expand and contract differently due to moist and or temperature. For example, typical polymers used for making carpet are polyamide, polyester and polyalkylene. These polymers have totally different deformation characteristics due to moist and temperature.

Gluing the carpet firmly to the surface to be covered may be an appropriate solution for those applications were the carpet may be firmly anchored to the surface, such as for most domestic appliances. However, for other applications gluing is not found convenient. For example, gluing is not an option in public areas where part of the surface covering is regularly exchanged due to high wear (shops, airplanes, cruise ships). Other examples are entrance mats and car mats that must be easy to remove from the surface for cleaning. Carpet tiles must also typically be removable from the surface to provide easy cleaning and replacement.

Another solution, mainly applied the art of laminated carpet tiles, entrance mats and runners, is to simply provide a thick enough second sheet that is dimensionally stable per se, to counteract any internal strain. Typically, thick bituminous layers are provided for this purpose. Disadvantage is that the total weight of the carpet then often exceeds 4.0 kg/m², which makes the carpet not only expensive to make (increased weight inherently adds costs), but also more difficult to process and handle.

DE 2850102 proposes to use of a thick dimensionally stable second sheet as a bottom layer and a woven intermediate layer. Woven layers are typically mechanically continuous in the horizontal plane and therefore provide a good mechanical stability in the horizontal plane (to prevent stretch). However, they typically cannot prevent curling or bulging. This comes about due to the thick second sheet. Disadvantage of such a layer is that the carpet tile is quite heavy and fairly rigid.

In EP 382349 it is proposed to use a dimensionally stable (glass-fibre) intermediate layer in combination with a second sheet (the tile backing), which second sheet exactly counteracts the tension induced by the first sheet (the primary backing). This solution however restricts the type of second sheet that can be used to produce the carpet tremendously.

NL 8203180 proposes to apply a thick rigid bottom layer. An intermediate spongy layer (foam) is present, to prevent wear of the top-layer.

EP 297611 describes a laminated textile product using a thin and flexible bottom layer. To provide stability, a thick intermediate layer is provided. The intermediate layer has to absorb vertical distortion of the carpet. The layer preferably comprises air spaces or cells in either a sandwich structure comprising polyolefine films, multiple layers of fibrilated films, woven or non-woven fabrics or scrim embedded in adhesive. All of these layers provide sufficient rigidity in horizontal direction but still allow the tile to absorb vertical distortions.

U.S. Pat. No. 5,030,497 proposes to use a thick bituminous layer and a second layer of fibrous material impregnated with a hot melt adhesive. These layers provide a carpet tile that is very rigid such that curl can be prevented.

### OBJECT OF THE INVENTION

It is an object of the invention to provide an alternative solution to prevent or at least mitigate the problem of internal strain associated with laminated textile products, which solution does not depend on the presence of a thick rigid layer that counteracts the strain.

### SUMMARY OF THE INVENTION

In order to meet the object of the invention a laminated textile product as defined in the GENERAL FIELD OF THE INVENTION section has been devised, wherein the second surface of the first sheet is calendered and the intermediate layer is resilient to allow local deformation of this layer along the second surface of the first sheet or along the surface of the second sheet adjacent to the intermediate layer. It was surprisingly found that even for a textile product which has a weight below 4.0 kg/m², when the second surface is calendered, the resilient property according to the present invention is able to prevent or at least mitigate the problem arising from internal strain. Without being bound to theory, it is believed that due to the resilient properties as defined here above, it is provided that each of the sheets may expand or contract (“deform”) in the horizontal direction independently of an expansion or contraction of the second sheet, and thus, that no (or only low) internal strain (which may lead to curl or other deformation) may arise. This can be understood as follows: due to the resiliency of the intermediate layer which allows local deformation of the material in this layer along the surface of at least one sheet, the horizontal deformation of (one of) the sheet(s) may now be locally absorbed by the intermediate layer, without mechanical forces being transferred directly from the first sheet to the second sheet or vice versa. This means that a high carpet weight is no longer needed to prevent deformation. The calendering of the first sheet as such is a method known in the art (for example as described in EP1598476, assigned to Klieverik Heli) and is typically used to mechanically bond the yarns to the (second surface of the) first sheet. However, such a calendaring process also increases the susceptibility of the first sheet for deformation under different moist and temperatures since in fact a new (continuous or sub-continuous) layer is formed at the second surface of the first sheet, but now existing out of the material of the yarns. Such a layer almost inherently has different deformation properties than the first and second sheet. Still, without exactly understanding why, in combination with the resilient layer as defined here above, a laminated product may be obtained in which independent horizontal deformation of the various sheets does not necessarily lead to excessive internal strain and hence, curling, bulging or other related problems of textile products. Indeed, the magnitude of allowed independent horizontal deformation of the sheets depends on the magnitude of resiliency of the intermediate layer. In practice, the maximum needed independent deformation can be established easily by subjecting the two sheets to the normal environmental variations for an environment in which the carpet is going to be used, and establish how different the deformations are. The bigger the difference in deformation of the respective sheets is, the more resilient the intermediate layer has to be (the more local deformation is needed). Although there are many ways in which a resilient layer according to the invention can be constituted, the common properties are that such a layer has a relatively open (not massive) structure, is resilient and does not have horizontal rigid layers along both surfaces that cannot deform substantially independently. This provides that the intermediate layer can deform locally along the surface of at least one of the sheets without substantially transferring deformation forces to the surface of the other sheet.

The solution therefore is totally contradictory to what the prior art proposes for preventing problems associated with internal strain. The present invention proposes to use a very resilient intermediate layer, in combination with a calendered first sheet, whereas the prior art proposes to use the first sheet as such (not calendered), in combination with massive, heavy structures or other rigid layers to provide for a heavy weight, inherently stable carpet. Surprisingly it has been found that with the resilient intermediate layer in the laminated carpet of the present invention, even when the weight of the carpet is as low as 4.0 kg/m², for example as low as 3.9, 3.8, 3.7, 3.6, 3.5, 3.4, 3.3, 3.2, 3.1, 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1 or even 1.0 kg/m² or below, problems associated with internal strain can be prevented completely. A reasonable practical minimum amount of the carpet weight will be about 0.5 kg/m².

The invention also pertains to a method to produce a textile product comprising providing a first sheet having yarns fastened thereto, the first sheet having a first surface and a second surface, the yarns extending from the first surface, laminating this first sheet with its second surface to a second sheet while providing an intermediate layer between the first sheet and the second sheet, wherein the second surface of the first sheet is subjected to a calendering process before being laminated to the second sheet, and the intermediate layer used is resilient to allow local deformation of this layer along the second surface of the first sheet or along the surface of the second sheet adjacent to the intermediate layer. Using this method, stable textile products can be obtained having a weight as lows as 4.0 kg/m², for example as low as 3.9, 3.8, 3.7, 3.6, 3.5, 3.4, 3.3, 3.2, 3.1, 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1 or even 1.0 kg/m² or below. A reasonable practical minimum amount of the carpet weight will be about 0.5 kg/m².

The invention also pertains to a method to recycle a laminated textile product as defined here above as a tile according to the invention wherein the textile product is shredded into pieces having a diameter between 0.01 and 1 cm, the method optionally comprising delaminating the first and/or second sheet before the remaining part of the textile product or delaminated sheet is shredded.

The invention further pertains to the use of a textile product according to the invention to cover a surface of a building, either interior or exterior, or any other artificial or natural construction such as for example an exhibition stand, a car, trailer, boat, aeroplane, terrace, foot path, road, garden etc. The invention also pertains to the building or other artificial or natural construction having a surface covered this way.

### DEFINITIONS

A textile product is a product that comprises textile (i.e. material made mainly of natural or artificial fibres, often referred to as thread or yarn), with other components such as backing layers, carrier layers and/or adhesives. Laminated textile products typically comprise an upper layer of pile attached to a backing (where the raised pile fibres are also denoted as the “nap” of the product) but may also be flat weave. Such products can be of various different constructions such as woven, needle felt, knotted, tufted and/or embroidered, though tufted products are the most common type. The pile may be cut (as in a plush carpet) or form loops (as in a Berber carpet).

Calendering is a finishing process used to make a textile product more smooth and optionally glossy by applying pressure, heat or a combination of pressure and heat to the textile product.

A sheet is a substantially two dimensional mass or material, i.e. a broad and thin, typically, but not necessarily, rectangular in form.

The horizontal direction in relation to a laminated textile product is the two-dimensional plane in which the laminated textile product extends.

A laminate is a structure comprising multiple stacked layers mechanically connected to each other.

Resilient means to be able and deform and automatically return to the original configuration.

A hot melt adhesive is a thermoplastic adhesive that is designed to be melted, i.e. heated to transform from a solid state into a liquid state to adhere materials after solidification. Hot melt adhesives are typically non-reactive, crystalline and comprise low or no amount of solvents so curing and drying are typically not necessary in order to provide adequate adhesion.

Fibrous means consisting basically out of fibres. “Basically” means that the basic mechanical constitution is arranged out of fibres: the fibres may however be impregnated or otherwise treated or combined with a non-fibrous material such that the end material also comprises other constituents than fibres. Typical fibrous sheets are woven and non-woven textile products, or combinations thereof.

### EMBODIMENTS OF THE INVENTION

In a first embodiment of the invention the intermediate layer is resilient to allow local deformation of the layer along the second surface of the first sheet and along the surface of the second sheet adjacent to the intermediate layer. In this embodiment local deformation in the layer is allowed along the surfaces of both sheets. This allows even greater independent deformation of the sheets. This may be necessary where for example humidity and temperature varies considerably such as in non air-conditioned rooms.

In another embodiment the intermediate layer is mechanically discontinuous in two perpendicular horizontal directions. Mechanical discontinuity allows for bigger local deformations without transferring forces to the neighbouring areas. For example, using an open foam that has in a horizontal plane considerably more “air” than polymer, is able to resist transfer of forces better than a mechanically continuous but very elastic material.

In yet another embodiment the intermediate layer is a fibrous layer. Fibres can be easily assembled to form a stable layer, and still provide for the option of local deformation. For example when fibres are entangled but not mechanically connected at the sites were fibres cross, deformation may stay locally, while the layer as a whole has significant mechanical stability.

In still another embodiment the intermediate layer is a non woven layer. Non woven layers are easy to assemble, even when using very short fibres and are therefore economically attractive. While short fibres may prevent deformation to be easy transferred over distances considerably longer than the fibres themselves, long fibres, due to the non-woven arrangement (for example meandering like a river) may also be perfectly capable of allowing local deformation and not transferring forces to the neighbouring areas.

In again another embodiment the intermediate layer is a knitted layer. A knitted layer, although the fibres are in essence endless, appears to be perfectly suitable to allow only local deformation. Like a tubular knitted sock that fits every curve of a foot, a knitted layer can easily deform locally without transferring forces to neighboring areas.

In yet another embodiment the first sheet and/or second sheet are laminated with a hot melt adhesive (which does not exclude that the hot melt adhesive is combined with another type of adhesive). It was expected that due to the resiliency a hot melt adhesive would be unsuitable to laminate a sheet to the intermediate layer. A hot melt adhesive, due to its crystalline properties, is relatively brittle when cold. As such, it was expected that the local deformation of the intermediate layer would lead to breakage of the adhesive and hence delamination. Surprisingly, this does not appear to be the case. The reason for this is unclear. In a further embodiment the hot melt adhesive comprises at least 50% by weight of a polymer chosen from the group consisting of (co)polyurethane(s), (co)polycarbonate(s), (co)polyester(s), (co)polyamide(s), (co)poly(ester-amide(s), mixtures thereof and/or copolymers thereof. This provides for example the option to choose an adhesive of the same type of polymer as used for constituting the sheets. This may help when recycling the textile product.

In an embodiment of the method to produce a textile product, during the calendering process the second surface is treated by applying heat such that the yarns adjacent the second surface are at least partly molten during the calendering process. Due to the fact that the yarns are at least partly molten, the calendering process may lead to an even more smooth and glossy surface. Although it was expected that this would lead to even more internal strain (due to the fact that the previous discontinuous assembly of yarns is transformed into a more or less continuous layer), it appeared that this embodiment may lead to very stable textile products.

In yet another embodiment the molten fraction of the yarns is spread in a direction parallel to the first surface of the first sheet by imparting a mechanical force on the molten fraction of the yarns in the said direction. This mechanical force may lead to yet again an improved calendaring process, virtually uniting the yarn elements at the back into one continuous layer of material. In a further embodiment the calendaring process takes place by pressing the second surface of the first sheet against a heated body that has a relative speed with respect to the second surface.

It is noted that the methods and uses as recited in the SUMMARY OF THE INVENTION SECTION can be applied with any of the embodiments as described here above.

Described here below, up to the EXAMPLES section are other embodiments based on the gist of the invention. These embodiments all relate to a method for manufacturing a textile product, the method comprising the steps of:
a) providing a first product (e.g. a first sheet) with yarns fastened thereto where the first product (e.g. first sheet) has a first surface (e.g. a front surface) and a second surface (e.g. back surface) and the yarns extend from the first surface of the first product,
b) heating the second surface of the first product thereby at least partly melting the yarns fastened to the first product to bond the yarns to the first product
c) exposing the second surface of the first product to pressure;
d) optionally imparting mechanical force to the molten fraction of the yarns in a direction parallel to the surface of the first product;
e) applying hot melt adhesive to the second surface of the first product;
f) applying a dimensionally stable second sheet to the first product, where the yarn-bearing first sheet has an expansion coefficient that differs from an expansion coefficient of the second sheet; and
g) applying an additional sheet so in the textile product the additional sheet is located between the yarn-bearing first sheet and the dimensionally stable second sheet to prevent delamination and/or deformation of the first sheet and/or the second sheet due to different expansion.

Optionally the additional sheet moves (e.g. expand or contract) in an amount which is between that amount the first and the second sheet would move (e.g. expand or contract) relative to one another if the first and second sheets were allowed to move freely with respect to each other.

In one embodiment of this method step (g) is performed before step (f) and in step (g) the additional sheet is applied to the second surface of the yarn-bearing first sheet and then in step (f) the dimensionally stable second sheet is applied to the surface of the additional sheet which is not adjacent to the first sheet.

In another embodiment of the invention step (g) is performed before step (f) and in step (g) the additional sheet is applied to a surface of the dimensionally stable second sheet to form an intermediate laminate and then in step (f) the intermediate laminate (comprising the dimensionally stable second sheet) is applied to the second surface of the yarn-bearing first sheet so the additional sheet is between the first sheet and the second sheet.

In another embodiment of the invention in step (g) the additional sheet is applied between the yarn-bearing first sheet and the dimensionally stable second sheet and optionally steps (f) and (g) are performed simultaneously.

The expansion coefficients referred to herein may denote either thermal expansion coefficients or moisture expansion coefficients or both together. The thermal expansion coefficient (TEC) is a measure of how much a material expands when exposed to increased temperature and is defined as the amount of expansion (or contraction) per unit length of a material resulting from one degree change in temperature (also called expansivity). Preferably TEC is measured herein when temperature is varied between 20° and 28° C.

The coefficient of moisture expansion (also referred to as CME or also as coefficient of hygroscopic expansion or CHE) is a measure of how much a material expands when exposed to increased ambient moisture (i.e. humidity). CME is defined as the fractional increase in strain per unit mass due to moisture absorption or desorption) and is determined by measuring the moisture content change and the strain change between two moisture equilibrium states. CME values may differ for example due to differences in the rate absorption of water by different layers. Preferably the CME is measured herein when relative humidity (RH) is varied between 30% and 60% (referred to herein as under Moisture Test Conditions). CME may also be measured herein using the method described in ASTM C272 (Water Absorption of Core materials for Structural Sandwich Constructions).

If in a textile product the differences between the TEC and/or CME of adjacent layers are too great the textile product can delaminate and/or deform when exposed to a sufficiently large change in temperature and/or relative humidity. Thus for many textile products it is preferred that the expansion coefficients of the yarn bearing first sheet and the dimensionally stable second sheet are either the same or closely matched. In this way delamination and deformation can be reduced or eliminated. However this limitation can significantly limit the choice of materials and one advantage of the invention is that use of an intermediate additional layer allows for a wider range of other materials, layers and/or constructions to be used as there is a reduced need to closely match their expansion coefficients. Therefore in yet another embodiment of the method in steps (f) and/or (g) at least one preferably both of the thermal and/or moisture expansion coefficients of the first sheet and of the second sheets are different from each other.

In still another embodiment of the method at least one expansion coefficient(s) of the additional sheet (which is optionally resilient) is different from at least one expansion coefficient(s) of the yarn-bearing first sheet and/or also from at least one expansion coefficient(s) of dimensionally stable second sheet. In this embodiment it is preferred that the additional sheet expands to a degree which lies between the amount of expansion of the yarn-bearing first sheet and the amount of expansion of dimensionally stable second sheet.

Preferably in step (a) the yarns are fastened temporarily to the first sheet. The first sheet may also be referred to herein as the yarn-bearing sheet. The first surface of the first sheet may for example also be denoted the front surface and the second surface of the first sheet may for example also be denoted the back surface.

Optionally the yarns of the first sheet may additionally extend from the second (e.g. back) surface of the first sheet. Thus the yarns may extend from both first and second surfaces (e.g. front and back) of the first sheet.

The steps (a), (b) (c), (e), (f) and (g) in the embodied method of the invention may be performed sequentially in the above order [i.e. step (a) then (b) then (c) then (e) then (f) then (g)] and/or with some or all of these steps being performed together simultaneously (with the optional steps (d) if present also being performed in the above sequence and/or simultaneously). For example steps (b), (c) and (d) where present may be performed at the same time. It is more preferred that step (e) is performed after step (d) where present. It is more preferred that step (g) is performed either together with or before step (f), for example as described herein in various embodiments of the invention.

In one aspect of the invention the first sheet of the present invention may be equivalent to (or comprise) what is often referred to in the prior art as a primary layer (also known as a primary backing and/or primary matt) and/or the second sheet and/or the additional (e.g. resilient) sheet of the present invention may together or separately each be equivalent to (or comprise) what is often referred to in the prior art as a secondary layer (also known as a secondary backing, carrier material and/or support layer). However terms such as ‘primary layer’ and ‘secondary layer’ and the like used in the prior art may also have a meaning different from and independent of the terms ‘first sheet’ and ‘second sheet’ as used herein to describe the present invention. So the terms primary layer and first sheet and the terms secondary layer and second sheet do not necessarily correspond to similar features described in prior art textile products.

Usefully the textile product is manufactured from one or more sheets (including for example continuous webs fed from a roll) that pass through a machine. Conventionally the longitudinal direction (LD) is the direction in which the sheet(s) pass through the machine (also known as the machine direction or MD) and the transverse direction (TD) (also known as the tangential direction) is perpendicular to MD in the plane of the sheet. Therefore in step (d) it is preferred that a mechanical force on the molten fraction of the yarns is applied in the longitudinal direction and/or transverse direction, preferably in the longitudinal direction. The mechanical force may be applied by any suitable method or device (for example any known to those skilled in the art) and be applied simultaneously and/or sequentially in each of two mutually perpendicular directions (e.g. MD and/or TD) for example by the method described in WO 2012/076348, by a stenter, by draw rolls and/or by any combinations thereof.

In optional step (d) the molten fraction of the yarns may be spread across the second (e.g. back) surface of the first sheet (preferably in the MD) sufficiently to provide a smooth surface on those parts of the second (e.g. back) surface of the first sheet where the molten yarn has been spread to act as a good base for applying hot melt glue, for example to attach the second sheet to the first sheet. Thus preferably step (d) acts to calender (make smooth) at least a part of the second (e.g. back) surface of the first sheet.

Thus in one embodiment of the method of the invention, the second (e.g. back) surface of the first sheet is calendered in whole or in part and adhesive is provided by applying molten adhesive on the calendered second (e.g. back) surface of the first sheet, and where the calendered second (e.g. back) surface of the first sheet has a temperature above the melting temperature of the hot melt adhesive when the adhesive is applied.

In another embodiment of the method of the invention an intermediate product is obtained from step (a), the product being a primary backing sheet to which the yarns are not yet strongly bound to the sheet (i.e. are temporarily attached). In a further embodiment (optionally as preferred feature of the previous embodiment) of the method of the invention, a primary mat sheet is obtained as the product of step (b) and/or step (e) where in the primary mat sheet the yarns are strongly bound to the sheet (i.e. permanently attached) by respectively thermal treatment and/or by adhesive optionally so that the yarn tufts protrude from the first (e.g. front) surface of the primary mat sheet.

It is preferred that step (d) is performed substantially at the same time or immediately after steps (b) and (c) and more preferably is performed before steps (e) and/or (f).

The textile product that results from this embodiment comprises:
I) a first sheet with yarns fastened thereto by
   (i) a first fastener where the first sheet has a first surface and a second surface and the yarns extend from the first surface of the first sheet; and
   (ii) a second fastener where the yarns have been fused at least in part to the first sheet and/or each other optionally by heat and/or pressure;
   (iii) a third fastener comprising a hot melt adhesive (HMA) substantially located on the second surface of the first sheet;
II) a dimensionally stable second sheet optionally attached to the textile product by the hot melt adhesive; where the yarn-bearing first sheet has an expansion coefficient that differs from an expansion coefficient of the second sheet; and
III) an additional sheet between the yarn-bearing first sheet and the dimensionally stable second sheet to prevent delamination and/or deformation of the first sheet and/or the second sheet due to different expansion

The additional sheets is preferably located directly in between the yarn bearing first sheet and the dimensionally stable second sheet and can be attached by applying a suitable adhesive to either or both surfaces of the additional sheet and/or the surfaces of the first and/or second sheets to which it is attached. Suitable adhesives may any of those described herein, for example hot melt adhesive (HMA).

Preferably in component II and III the expansion coefficients of the first and second sheets are different when measured when temperature varies between 15° and 35° C. (more preferably between 20° and 28° C.) and/or relative humidity (RH) varies between 30% and 60% (more preferably between 35% and 55%) and where advantageously both temperature and RH vary within at least one of these ranges (=Test Conditions).

Thus if the first and second sheets expand differently the additional sheet can deform to allow relative movement between the sheets. Alternatively the additional sheet may be sufficiently strong and may not substantially deform but rather substantially holds the first and second sheets together to prevent substantial or any differential expansion between the sheets from taking place. Preferred additional sheets are resilient as defined herein. Preferred textile products are substantially reclaimable (e.g. recyclable).

In another embodiment the product of step (I)(i) is a primary backing sheet where the yarns are temporarily attached to the sheet. In yet another embodiment of the present invention the product of step (I)(ii) and/or step (I)(ii) is a primary mat sheet where the yarns are permanently attached to the sheet by respectively thermal treatment and/or adhesive, preferably by both. Preferred textile products of the invention are substantially free of (more preferably free of) styrene block copolymers and/or rubber-based adhesives (such as SBR or SBS), Most preferred textile products of the invention are free of any cross-linkable polymer latex, for example any cross-linked polymer latex. Conveniently textile products of the invention comprise other than a first sheet and/or a second sheet that is not substantially impregnated with HMA, i.e. the first sheet and/or the second sheet (where present) is substantially free of (more conveniently free of) embedded HMA. Useful textile products of the invention are substantially free of (more usefully free of) chemically reactive adhesive.

The term “embedded” when used herein in relation to component materials used to prepare a textile product (e.g. in relation to HMA) denotes that the specified material (such as HMA) has been substantially impregnated within the structure of the first and/or second sheets and/or yarn fibres, for example is located in the interstices and/or voids within the sheets and yarn. Thus a non-embedded material (for example non-embedded HMA) denotes a material which is not widely impregnated having no more than 20%, preferably no more than 10%, more preferably no more than 5%, most preferably less than 1% by weight of the total amount of that material (such as HMA) present in the textile product embedded within the sheets and yarn as described above. Thus without being bound by any theory it is believed that for example non-embedded HMA forms a substantially continuous adhesive film at a surface of either or both sheets and/or forms a discrete layer between them. The presence or absence of embedded material (such as embedded HMA) can readily be determined by any suitable methods (such as by visual inspection, e.g. microscopy of a cross-section taken through the textile product).

Conveniently the first sheet described herein may be a web in which case the manufacturing process may be continuous for example using a roll of the first yarn-bearing sheet to form a web of textile product which may then be wound onto a roll. Alternatively the sheets may be cut into a pre-defined length in which case the manufacturing process may be a batch process producing many (optionally flat) sheets of textile product of the desired size.

In step (a) the yarns may optionally be attached temporarily which denotes that the yarn is not bonded sufficiently for use in the desired end application of the textile product (such as a floor covering) and so at least in theory the yarn and first sheet could readily become separated.

Preferred methods of attachment that are temporary are mechanical attachment methods, more preferably any methods in which yarns are joined to the first sheet by an interweaving-like method, even more preferred methods being selected from tufting, knitting, sewing, weaving and/or stitching, most preferably stitching where the yarn is fastened or joined with stitches. Mechanical attachment methods exclude other more permanent and irreversible methods to keep the yarns in place such as gluing, melting and/or chemically reacting.

The term fastener as used herein (for example to describe textile products of the invention) denotes any suitable method of attachment which may or may not be permanent or temporary and may comprise mechanical, chemical, adhesive and/or any other suitable methods and/or any combinations thereof for example any suitable methods known to those skilled in the art.

The method of heating in step (b) may comprise any suitable method as well as thermal heating (for example by a heated roller) such as heating by irradiation with suitable electromagnetic and/or particulate radiation e.g. using ultra-sound and/or infrared radiation. The heating and the pressure may be provided by the same method and/or device (e.g. an optionally heated pinch or nip roller). The heating may also be provided by pressure and/or irradiation alone without using a separate thermal input such as a heater. In one embodiment of the invention the absence of a separate thermal heater has the advantage of significant savings of energy and compactness in the machinery used in the process of the invention.

In another embodiment of the invention in step (b) the heating is preferably achieved with a hot surface (such as a heated roller), alternatively or additionally the heating is also achieved in whole or in part by applying a mechanical force between to the yarns and the first sheet to spread the yarn and enhance bonding. In step (b) optionally the sheet may be fed onto a heated surface at a speed different from the heated surface which imparts said mechanical force. In a preferred embodiment of the invention where the heater comprises a heated roller than the pressure may be applied in whole or in part by a pressure roller run at a different speed relative to that of the heated roller, for example as described in WO 20012-076348.

In step (c) the pressure may be applied in whole or in part by a pressure roller and optionally steps (b) and (c) may be performed simultaneously. Preferably the heating and pressure are applied by the same roller which may calendar the first sheet.

The first sheet (which in some embodiments herein may be a primary matt sheet) of the present invention has yarns/tufts fixed to it by the heating process b) and performs a function similar to the primary layer of a conventional textile product as described herein. However in one embodiment the textile product of present invention is sufficiently dimensionally stable not to require a second layer to support the first sheet.

In step (f) a dimensionally stable second sheet (also known as a carrier sheet, secondary backing or a support sheet) is applied to the back surface of the first sheet after steps (b) and/or (c) in which case in step (e) the hot melt adhesive (HMA) may be applied between the first and second sheets which may be pressed together to form a laminated textile product. Preferably the HMA from step (e) is the only adhesive used to glue the first and second sheets together and no further adhesive is needed.

FIG. 1 schematically shows a cross section of a carpet tile according to the invention

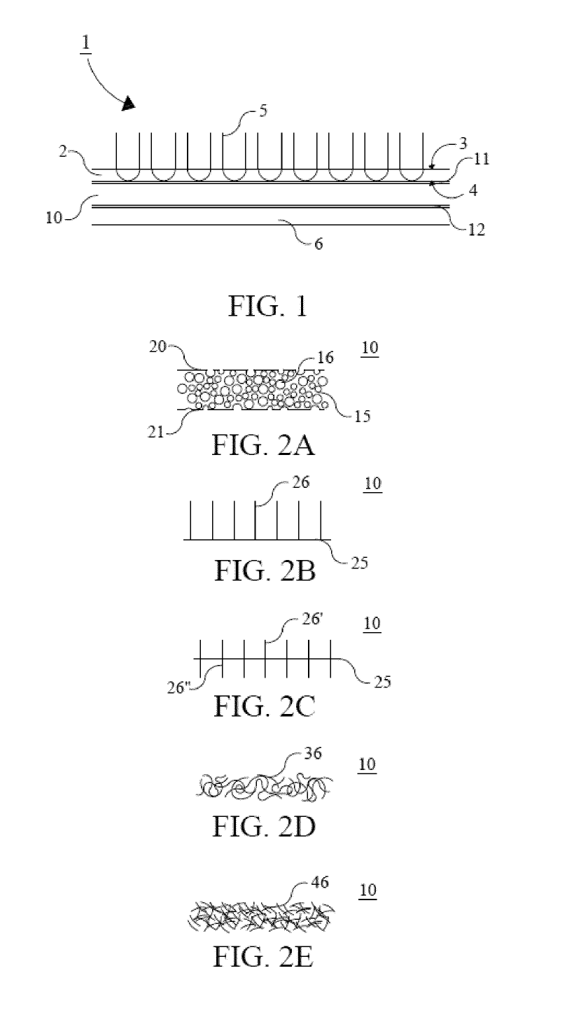

FIG. 2 schematically shows various types of resilient layers

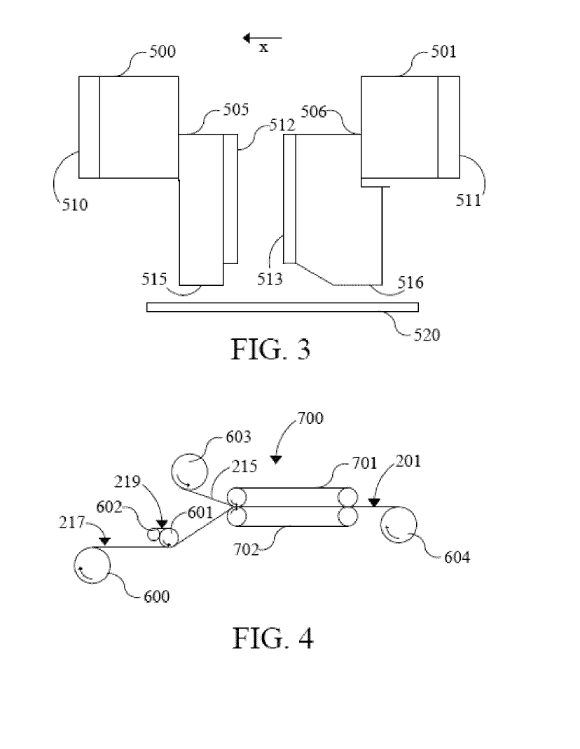

FIG. 3 schematically shows a configuration for applying a calendering process

FIG. 4 schematically represents a laminating configuration

### EXAMPLES

Example 1 describes a test method to establish the weight of a carpet tile

Example 2 outlines the basic technology to constitute laminated carpet tiles

Example 3 is an example of a laminated carpet tile according to the invention

Example 4 provides other examples of laminated carpet tiles according to the invention

Example 5 describes various resilient layers for use in the present invention

Example 6 provides the weight for various laminated carpet tiles

### Example 1

The weight of a textile product in kg/m2 can for example be established according to standardized test methods ISO 3801:1977 or AS (Australian Standard) 2001.2.13. In principle a standardized cutting tool is used to punch a sample having a predetermined area (in m²) out of a textile product. After that the mass of the punched sample is determined (in kg). The weight of the textile product is the found mass divided by the area of the sample.

### Example 2

Example 2 serves as an example to outline basic technology to constitute laminated textile products, i.e. suitable for producing laminated carpet tiles. For this, we herewith incorporate by reference, as a whole, the research disclosure database number 591084, published 25 Jun. 2013 in Research Disclosure (wwvv.researchdisclosure.com). In particular we refer to the examples section beginning on page 14, last but one line with “Some embodiments are described and shown . . . .” and ending on page 21, last line with “ . . . as broad loom carpets and/or as carpet tiles”.

In the same research disclosure, hot melt adhesives for use in the present invention are described. This section starts on page 8, line 21 with “Hot melt adhesives (HMA) are thermoplastic adhesives . . . .” and ends on page 14, lines 9/10 with “ . . . (maximum) temperature observed in this range.” and is herewith incorporated in its entirety to describe hot melt adhesives that can be used in the carpet tile according to the present invention or methods according to the present invention.

In particular in this example reference is made to FIG. 3 which schematically represents a configuration for applying a calendering process for use in the present invention. In the configuration shown in FIG. 3 a first heating block 500 and a second heating block 501 are present, in order to heat the heating elements, also denoted as heating blades or heating bodies, 505 and 506 respectively. These heating elements have a working surface 515 and 516 respectively, which surfaces are brought in contact with a product to be processed, typically a primary carrier to which yarns are applied via a stitching process such as tufting. The working surfaces both have a working width of 18 mm, and the intermediate distance is 26 mm. The back surface of the product is brought in contact with the working surfaces of the heating elements. In order to be able and apply adequate pressure for the product to be processed, a Teflon support 520 is present which is used to counteract a pushing force applied to the heating elements. In operation, the heating elements are moved relatively to the product in the indicated direction X. Typically, the heating elements are stationary and the product is forced to travel between the working surfaces and the Teflon support in a direction opposite to the direction indicated with X.

The product to be processed with the above described configuration consists of a primary sheet provided with a cut pile of polymeric yarns, tufted into the sheet. The yarns typically have a melting temperature of about 260-280° C. This product is processed using a temperature of the first heating element of 200-220° C., in order to pre-heat the product. The second heating element is kept at a temperature about 15° C. above the melting temperature of the yarns. To keep the temperatures at the required level, the heating blocks and heating elements are provided with layers of insulating material 510, 511, 512 and 513 respectively. The product is supplied at a speed of 12 mm per second (0.72 metre per minute) or higher, and the pressure applied with the heating elements is about 1.35 Newton per square centimetre. This results in a product having a calendered back surface, i.e. being smooth and glossy at the sites where the stitched yarns extend from the back surface.

FIG. 4 schematically represents a laminating configuration for applying a second sheet, in this case a dimensionally stable secondary backing sheet, in conjunction with an additional resilient layer according to the invention, to the back of the first sheet that is produced with a method as described in conjunction with FIG. 3. In this embodiment the term target sheet denotes either the separate resilient layer and second sheet applied one after the other in that order, or the combined laminate of them both applied together to the first sheet. Both the second sheet and the resilient layer may be of polyester. In this figure a first roller 600 is depicted on to which roller is wound a 2 metre wide web of the said (pre-fabricated) product made according to the method described in conjunction with FIG. 3. The product is unwound from the roller 600 to have its back-side 217 to come into contact with a second roller 601. This roller is provided to apply a layer of hot melt adhesive (HMA) 219 to the back side 217. For this, a bulk amount of HMA 219 is present and heated between the rollers 601 and 602. The thickness of this layer can be adjusted by adjusting the gap between these two rollers. Downstream of the site of HMA application is the target sheet 215, which sheet is unwound from roller 603. This sheet is pressed against the hot and tacky adhesive and cooled in the unit 700. This unit consists of two belts 701 and 702 which on the one hand press the target sheet 215 against the primary product, and on the other hand cools down the adhesive to below its solidification temperature. The resulting end product 201 is thereafter wound on roller 604. In an alternative embodiment the fibre-binding process as described in relation with FIG. 3 and the lamination process take place in line. In that case, the fibre-binding set-up as shown in FIG. 3 could be placed between roller 600 and roller 601. In this embodiment the applied HMA is the polyester of Example D as described in the Research Disclosure. A suitable temperature of the roller 601 at the site where this HMA is applied to the back-side of the primary backing is 140° C. By having a gap of 2 mm, the HMA, at a web speed of 2 m/min, roller 602 not revolving and roller 601 having a circumferential speed of ±1.6 m/min, will be applied with a thickness of about 500 g/m². This is adequate to glue the target sheet 215 to the primary backing (i.e. the first sheet).

In the embodiment wherein the yarns extend through the primary backing (thus not alone extend at the face side, but also through the back surface, for example as a loop), at least a part of each yarn that extends out of back surface is melted (typically a part of the yarns that runs more or less parallel to the backing surface). It was found that when the yarns extend out of the back surface they are easier to melt and the calendaring is also an easier process since the melted material in fact lies “on top of” the back surface. Another advantage is that the primary backing material itself may be chosen of a material that has a melting temperature far above that of the yarns, so that the backing itself remains completely unaffected by the melting process if desired. Also, this provides the advantage that a primary backing may be used that is more dimensionally stable at the high process temperature used for fibre-binding (i.e. the process to bind the yarns to the first sheet by the calendaring process).

In case the adhesive is provided by applying molten adhesive on the calendared surface, the calendared surface may have a temperature above the melting temperature of the hot melt adhesive. It was found that this way a product can be obtained having an even improved resistance to mechanical load. It is believed that due to the temperature of the back surface above the melting temperature of the hot melt adhesive, this adhesive can penetrate, for example on a molecular scale, the material of the calendered sheet (the yarns material and/or material of the first sheet itself) to provide for an even stronger result.

The hot melt adhesive may be optionally provided as a layer having a thickness of less than 1 mm, usefully less than 0.5 mm, more usefully from 0.2 to 0.4 mm. Whereas in the prior art carpets on the market, the hot melt layer typically has a thickness well above 1 mm, applicant found that when reducing the thickness of this layer to 1 mm or below an adequate adhesion can still be obtained. Therefore the adhesive layer present in textile products of the present invention may have preferred mean thickness of from 50 microns to 1 mm, more preferably from 0.1 mm to 0.8 mm, most preferably from 0.2 mm to 0.4 mm. The amount of HMA used to form the adhesive layer in textile products of the present invention may be from 0.01 to 1000 g/m² of HMA per area of the adhesive layer. In another embodiment the HMA may be applied in an amount of from 0.05 to 800 g/m². In a still yet other embodiment HMA may be applied in an amount from 0.1 to 600 g/m².

### Example 3

This is a first example of a laminated textile product according to the invention, in this embodiment a carpet tile. To arrive at this tile a resilient layer according to the invention may be added as intermediate layer between a first sheet and second sheet in any of carpets prepared as described in Example 2. An actual tile can be made out of (broadloom) carpet by dimensioning the carpet into adequate tiles.

In particular, FIG. 1 is a schematic representation of the respective layers of a carpet tile 1 according to the invention. The tile comprises a first sheet 2, the so called primary backing, which is a tufted nonwoven sealed nylon obtained from Shaw Industries, Dalton USA. The nylon yarns 5 extend from the first surface 3 of the sheet and are sealed to the second surface 4 of the sheet using the fibre binding method as described in example 2). The weight of this first sheet is 670 g per m². In order to provide mechanical stability, the tile 1 comprises a second sheet 6, in this case a backing of a polyester needle felt backing fleece obtained as Qualitex Nadelvlies from TWE, Emsdetten, Germany. The weight of this second sheet is about 800 g/m². In between the first and second sheet is a resilient layer 10, in this case a polyester expansion fleece having a weight of 330 g/m², which is obtained from TWE as Abstandsvliesstof, a non-woven fabric which has not been needle-punched. Both sides of this layer 10 are constructed of a mesh of 100% PET which has been only mechanically solidified. The thickness of this intermediate layer is about 4 mm. The three layers (first and second sheet and intermediate layer) are glued together using a polyester hot melt glue from DSM, Geleen, the Netherlands, applied as layers 11 and 12 at a weight of about 300 g/m². The total weight of the carpet tile is thus about 2.4 kg/m².

Because of the different deformation properties (in particular a different thermal expansion coefficient, which difference depends heavily on the relative humidity) of the nylon first sheet and the polyester second sheet there is a risk the carpet tile may curl or even delaminate during practical use due to internal strain, even when the two sheets are durably glued together using a HMA such as a polyester hot melt glue. The resilient layer 10 may prevent such curl and delamination under normal interior circumstances, even though the total weight of the tile is very low. The intermediate layer has adequate resilient properties, i.e. it is able to locally deform along the second surface 4 of the first sheet and along the surface of the second sheet 6 to prevent mechanical forces from being transferred directly between the first sheet and the second sheet, even when expanding or contracting at different magnitudes. In this example the different layers are interconnected using the same HMA applied in the form of a layer having a weight of about 300 g/m² (about 0.3 mm thick). However, different HMA's could be used for the two layers 11 and 12. Also, for connecting the second sheet (6) another type of adhesive (or other connection means) could be used, for example when de-coupling of the second sheet 6 from the intermediate layer 10 not necessary when recycling the end product (for example when the two layers are in essence made of the same polymer). In any case, by having a resilient intermediate layer present between the sheets, it appears that curl and due to the different deformation of the first sheet 2 and the second sheet 6 can be prevented when the temperature varies between 20° and 28° C. at a relatively humidity varies between 30% and 60%. These variations define recommended office conditions.

### Example 4

This example provides two further carpet tiles according to the invention named Niaga® 1 and Niaga® 2. Of the Niaga® 1 tile, the primary backing is a non woven polyester/polyamide backing (obtainable as Colback® from Bonar, Arnhem, The Netherlands). For tufting (10 needles per inch), nylon yarns are used. These yarns are sealed to the primary backing using the fibre binding method as described in example 2. The weight of this first sheet (including tufted yarns) is about 700 g/m². In order to provide mechanical stability, the tile comprises a secondary backing of polyester obtained as Artikel no 800309-900 from TWE Vliesstofwerke, Emsdetten, Germany, having a weight of 900 g/m². In between the first and second sheet is a resilient layer, in this case a knitted polyester layer (obtainable as Caliweb® from TWE, Emsdetten, Germany), having a thickness of about 1½ mm after calandering the layer to the primary backing. The weight of this knitted polyester layer is about 300 g/m². The primary backing with the knitted layer is glued to the secondary backing using a polyester hot melt glue from DSM, Geleen, the Netherlands, at a weight of about 300 g/m². The total weight of the carpet tile is thus about 2.2 kg/m². The Niaga® 2 tile as basically the same but is provided with an additional layer of a pressure sensitive adhesive (300 g/m²) to the bottom side of the secondary backing to provide the option to adhere the carpet tile to a surface.

### Example 5

This example describes various resilient layers for use in the present invention. The resilient layer for use in the textile product according to the present invention should allow local deformation of the material in this layer along the surface of at least one of the sheets, as explained here above in the SUMMARY OF THE INVENTION section. This local deformation may to a sufficient extent prevent that forces (strain) is passed to its surroundings in the resilient layer and ultimately to the other sheet. Resilient layers could be made in various constitutions but they all have in common that such a layer has a relatively open (not massive) structure, is resilient and does not have horizontal rigid layers along both surfaces that cannot deform substantially independently.

FIG. 2, composed of sub-figures A through E, schematically represents a number of examples of resilient layers 10 for use in the present invention. In FIG. 2A, the resilient layer 10 consist of an open foam structure 15. The foam is made of an elastic polymer and comprises a high content of air bubbles 16. These bubbles cross the upper and lower surfaces 20 and 21 of the structure 15 (in other words: there are no continuous closure layers provided at these surfaces 20 and 21). This way, the foam 15 can easily deform locally along any of the two surfaces 20 and 21 without forces being transferred substantially through the layer.

In FIG. 2B a resilient layer 10 is shown that comprises one continuous layer 25 at the bottom. This layer is provided with multiple individual fibres that are packed so dense that a next layer can be glued against the distal ends of the fibres. Each fibre can move individually at its top without passing any (significant) forces to neighbouring fibres.

In FIG. 2C an alternative arrangement of the fibre bearing sheet 25 as depicted in FIG. 2B is shown in order to create a resilient layer for use in the present invention. In this case, the sheet 25′ is provided with fibres 26′ and 26″ on both sides. This way, the resilient layer can deform locally along both sides of the layer 10.

In FIG. 2D a resilient layer 10 is depicted which consists of long entangled (braided) yarns 36, in this case according to an irregular pattern. By creating a package with a certain thickness (thicker than the yarn 36 itself), the layer may deform locally along both its surfaces.

In FIG. 2E yet another alternative resilient layer 10 is schematically shown. In this case the layer consists of needle-felted short fibres 46. Since the fibres 46 are not durably three dimensionally arranged (i.e. there is no durable mechanical interconnection to fix the position of the fibres), the layer may deform locally along both its surfaces.

### Example 6

In table 1 the weights of various textile products are given in kg/m2. The first two products are the Niaga® 1 and 2 products according to the invention as described here above in example 4. The second two products are experimental broadloom carpet (BL), and correspond to the Niaga® 1 and 2 materials although the resilient layer has been left out (broadloom carpet does not need to have the anti-curl properties). Next to this, the BL1 carpet has a secondary backing which is substantially thinner (weighing only 500 g/m²) which results in a very low total weight. The BL2 carpet has the same backing as the Niaga® 1 and 2 and products but has a substantially more dense tufting (12 needles per inch). The fifth products (“Rigid backing, Heuga”) is an experimental carpet tile based on a commercially available tile (Heuga 530, obtainable from Interface Nederland BV, Scherpenzeel, The Netherlands), but with a double backing thickness to resist curl. The sixth product (“Rigid backing, Desso”) is comparable to the third product but based on another commercially available carpet tile (AO72, obtainable from Desso, Waalwijk, The Netherlands). The other products are regular commercially available carpet tiles that have no special constitution to prevent curl (no intermediate rigid layers or rigid backing).

The products according to the invention have an increased resistance against curl when subjected to changes in environmental conditions (moist, temperature) when compared to products having the same laminated constitution (Niaga BL 1 and BL 2) but not having the resilient layer. The latter products appear to build up internal strain that eventually leads to curl even under normal office circumstances (i.e. the temperature varies between 20° and 28° C. and the relative humidity varies between 30% and 60%), whereas the Niaga 1 and 2 products do not. Their resistance against curl is comparable to or even better than that of the commercially available carpet tiles having a weight between 4.0 and 4.7 kg/m².

TABLE 1
Weights of various carpet tiles

| Textile product | weight in kg/m² |
|---|---|
| Niaga ® 1 | 2.2 |
| Niaga ® 2 | 2.5 |
| Niaga ® BL 1 | 1.9 |
| Niaga ® BL 2 | 2.7 |
| Rigid backing, Heuga ™ | 10.6 |
| Rigid Backing, Desso ™ | 10.1 |
| Interface GlasBac | 4.6 |
| Desso Airmaster ™ | 4.3 |
| Forbo Westbond Honiton ™ | 4.2 |
| Tecsom Summer orange ™ | 4.7 |
| Desso Classic A527 ™ | 4.0 |

1. Textile product which is a laminate of:
a first sheet having yarns fastened thereto, the first sheet having a first surface and a second surface, the yarns extending from the first surface,
a second sheet and
an intermediate layer between the second surface of the first sheet and the second sheet,
wherein the second surface of the first sheet is calendered and the intermediate layer is resilient to allow local deformation of this layer along the second surface of the first sheet or along the surface of the second sheet adjacent to the intermediate layer.

2. Textile product according to claim 1, wherein the layer is resilient to allow local deformation of the layer along the second surface of the first sheet and along the surface of the second sheet adjacent to the intermediate layer.

3. Textile product according to claim 1, wherein the intermediate layer is mechanically discontinuous in two perpendicular horizontal directions.

4. Textile product according to claim 1, wherein the intermediate layer is a fibrous layer.

5. Textile product according to claim 1, wherein the intermediate layer is a non woven layer.

6. Textile product according to claim 1, wherein the intermediate layer is a knitted layer.

7. Textile product according to claim 1, wherein the first sheet and/or second sheet are laminated with a hot melt adhesive.

8. Textile product according to claim 9, wherein the hot melt adhesive comprises at least 50% by weight of a polymer chosen from the group consisting of (co)polyurethane(s), (co)polycarbonate(s), (co)polyester(s), (co)polyamide(s), (co)poly(ester-amide(s), mixtures thereof and/or copolymers thereof.

9. Method to produce a textile product comprising providing a first sheet having yarns fastened thereto, the first sheet having a first surface and a second surface, the yarns extending from the first surface, laminating this first sheet with its second surface to a second sheet while providing an intermediate layer between the first sheet and the second sheet, wherein the second surface of the first sheet is subjected to a calendering process before being laminated to the second sheet, and the intermediate layer used is resilient to allow local deformation of this layer along the second surface of the first sheet or along the surface of the second sheet adjacent to the intermediate layer.

10. Method according to claim 9, wherein during the calendering process the second surface is treated by applying heat such that the yarns adjacent the second surface are at least partly molten during the calendering process.

11. Method according to claim 10, wherein the molten fraction of the yarns is spread in a direction parallel to the first surface of the first sheet by imparting a mechanical force on the molten fraction of the yarns in the said direction.

12. Method according to claim 11, wherein the calendaring process takes place by pressing the second surface of the first sheet against a heated body that has a relative speed with respect to the second surface.

13. Method to recycle a textile product according to claim 1, wherein the textile product is shredded into pieces having a diameter between 0.01 and 1 cm, the method optionally comprising delaminating the first and/or second sheet before the remaining part of the textile product or delaminated sheet is shredded.

14. Use of textile product according to claim 1, to cover a surface of a building or any other artificial or natural construction.

15. A building or any other artificial or natural construction having a surface covered with a textile product according to claim 1.
